(19) United States
(12) Patent Application Publication
(10) Pub. No.: US 2025/0029288 A1
(43) Pub. Date: Jan. 23, 2025

(54) Image Generation with Encoding Semi-structured Multimodal Entity Signature

(71) Applicant: Google LLC, Mountain View, CA (US)

(72) Inventors: Arjun Akula, Sunnyvale, CA (US); Garima Pruthi, San Jose, CA (US)

(21) Appl. No.: 18/392,407

(22) Filed: Dec. 21, 2023

Related U.S. Application Data
(60) Provisional application No. 63/527,627, filed on Jul. 19, 2023.

(51) Int. Cl. G06T 11/00

(52) U.S. Cl. CPC G06T 11/00

(57) ABSTRACT

This application discloses technology generally relating to a method for generating production-ready images using entity-specific signature information. The methods may include receiving signature inputs relating to signature elements such as logos, attributes, and target audiences. Further, the signature elements may be stored and incorporated into the image generation model to create images relevant to the specific entity. To generate the images using the entity-specific signature, the image generation model determines which signature elements to incorporate into the image based on what is most related to a generative request.

### CROSS REFERENCE TO RELATED APPLICATIONS

This application claims the benefit of the filing date of U.S. Provisional Patent Application No. 63/527,627 filed Jul. 19, 2023, the disclosure of which is hereby incorporated herein by reference.

### BACKGROUND

Typically, entities create digital content for potential use in reserved content space on a publisher's website or mobile application. The digital content can be part of a digital content campaign. In response to a user's query, digital content created by an entity is identified. The identified digital content is typically related to the search query and/or the preferences of the user submitting the search query. Generating imagery for digital content can be time-consuming and expensive. For example, to achieve an aesthetic depiction of a product, such as a sneaker or a bottle of perfume, the product typically needs to be positioned and lighted to accentuate certain elements. The elements may also include additional wording, components arranged in a setting, a background scene, or any wide variety of other objects.

Typically, multiple iterations of the same image are created by rearranging the elements in multiple configurations. Creating multiple iterations of the image requires time, studio space, and the like, which can become expensive and still result in digital content that does not capture all the elements of a product. Further, having to create and edit multiple iterations increases the computational requirements, by having to increase the amount of processing power to create and edit each iteration and having to increase the amount of memory required to store each iteration.

With the rapid advances in generative AI research, systems are being developed to enable entities to automatically customize a given input image to capture entity-specific styles. Such a capability can have a wide range of use cases in e-commerce to improve the digital customer experience. Some entities utilize machine learning models, such as generative models, to create variations of the digital content. The models can fail to produce images that are ready for immediate production without further editing by the entity.

State-of-the-art text-to-image generation models, although shown to capture high-level aspects of entities, fail to capture or preserve the detailed entity-specific elements in the generation. One option to address this is to add the entity-specific elements after the generation of the image, but the problem here is that the elements could look out of place and may not blend nicely with the background image, making the generated image not ready for production use cases. Generative models are limited by the inability to adapt to the target domain of the images with additional entity-specific signatures. Some text-to-image models may store and use full images of entity-specific elements, such as logos or slogans including specific fonts and colors. These text-to-image generation models must parse through large amounts of bulky and cumbersome image files to attempt to match the styles of the generated image. This requires large additional computational resources and may slow the process of generating an image in response to a prompt. Further, by using already formed images of the entity-specific elements, the text-to-image generation models may produce images with poorly integrated entity-specific elements. The generative models are limited by the images of the entity-specific elements it has access to.

### BRIEF SUMMARY

The present disclosure provides for generating production-ready images using entity-specific signature information. The imagery includes entity-specific images that are generated in response to verbal or textual inputs. The imagery may also include objects, such as a product that is the subject of the digital content. Signature information relating to signature elements may be provided as inference data into an image generation model. The signature elements may be, for example, logos, attributes, and target viewers. According to some examples, the signature elements may be stored and incorporated into the image generation model to create, using the image generation model, images relevant to a specific entity. To generate the images using the entity-specific signature, the image generation model may automatically identify which signature elements to incorporate into the image based on a generative request. In some examples, the image generation model may select one or more of the signature elements to incorporate into the generated image.

One aspect of the technology is directed to a method comprising receiving, by one or more processors, a signature associated with an entity, wherein the signature includes a plurality of signature elements, storing, at a memory in communication with the one or more processors, the signature, and receiving, by the one or more processors, a request for an image from a requestor, wherein the request includes the signature and specifications for the image. In response to receiving the request, the method may further comprise selecting, by the one or more processors, at least one of the plurality of signature elements to incorporate into a response to the request, and generating, by the one or more processors based on the specifications for the image, an image incorporating the at least one of the selected signature elements.

The signature may be a semi-structured set of data composed of multimodal inputs. The signature may be defined from inputs from a user. The signature may be defined from inputs from artificial intelligence techniques.

The selecting may further comprise determining which of the plurality of signature elements are compatible with the specifications of the request. The selecting may comprise selecting less than all of the signature elements to be incorporated into the response for the request.

The signature elements associated with the entity may include at least one of the following: entity name, color, slogan, visual elements of logo, attributes of the entity. The request may further incorporate a marketing message. The request may further incorporate at least one target emotion.

The signature elements may be ranked by level of importance, and selecting at least one signature element may be based on the ranking of the signature elements. The method may further comprise providing the generated image to the requestor. The generated image may not require additional input from the requestor. The generated image may not require subsequent or repeat requests for additional images to be generated from the requestor.

Another aspect of the technology is directed to a system comprising memory and one or more processing in communication with the memory. The one or more processors may be configured to receive a signature associated with an entity, wherein the signature includes a plurality of signature elements, store, in the memory, the signature, and receive a request for an image from a requestor, wherein the request includes the signature and specifications for the image. In response to receiving the request, the one or more processors may be configured to select at least one of the plurality of signature elements to incorporate into a response to the request, and generate, based on the specifications of the request, an image incorporating at least one of the selected signature elements.

Yet another aspect of the technology is directed to a computer-readable medium storing instructions, which when executed by one or more processors, cause the one or more processors to receive a signature associated with an entity, wherein the signature includes a plurality of signature elements, store, in the memory, the signature, and receive a request for an image from a requestor, wherein the request includes the signature and specifications for the image. In response to receiving the request, the one or more processors may be configured to select at least one of the plurality of signature elements to incorporate into a response to the request, and generate, based on the specifications of the request, an image incorporating at least one of the selected signature elements.

### BRIEF DESCRIPTION OF THE DRAWINGS

FIG. 1 is a pictorial diagram illustrating an example system according to aspects of the disclosure.

FIG. 2 is a block diagram illustrating an example computing environment according to aspects of the disclosure.

FIG. 3 is a pictorial representation of an example user interface for manually creating a signature to aspects of the disclosure.

FIGS. 4A-B are pictorial representations of example user interfaces for alternatively creating a signature according to aspects of the disclosure.

FIGS. 5A-D are pictorial representations of examples of the text-to-image generation options according to aspects of the disclosure.

FIG. 6 is a flow diagram illustrating an example system according to aspects of the disclosure.

### DETAILED DESCRIPTION

### I. Understanding and Receiving Signature Inputs

The technology described in this disclosure relates to developing generative modeling techniques. The generative modeling techniques may allow an entity to define its desired signature that can be used as training data for a generative model, along with corresponding textual descriptions. A signature may be a grouping of elements that relate to an entity, such as a logo, slogan, font, color, target audience, aesthetics. The signature inputs, also referred to herein as signature elements, may be stored in a basic, textual form, such that the image generation methods may produce a wide variety of digital components without storing all possible styling elements. The generation model may develop a style guide specific to an entity based on data provided, e.g., the signature elements, or generated about the entity to more efficiently utilize the resources of a system.

The inputs may be simple inputs, e.g., textual inputs, into the generative model as compared to complex inputs, e.g., image inputs. The simple input may provide for more simple processing techniques. In some examples, by using simple inputs to provide for simple processing, the computational efficiency of the system utilizing the generative model may be increased. For example, by using and/or storing the signature elements in a textual form, the signature elements may be stored more efficiently as they would require less data storage compared to storing the signature elements in image form, such as a JPEG, GIF, PNG, or the like. This reduces the amount of memory required by the system. Further, by using simple inputs, the processing of the inputs may be simplified thereby decreasing the amount of processing required to generate an output. Transferring text data requires less bandwidth than transferring image data. Therefore, the system may conserve computational resources when generating images. Specifically, being that the textual form elements are made of smaller data than image data, the system expends less resources as parsing and analyzing large images is no longer needed, which reduces the cost of operating the system compared to processing image data.

The technology described herein provides for increased accuracy while maintaining flexibility in generating images and content related to specific entities. A processor may more reliably process smaller textual form elements compared to image data, resulting in highly reliable image generation outputs. Specifically, the system may more accurately respond to an image generation prompt that includes a specific entity name by using the information from a signature registry relating to that entity. Accuracy in responding to the prompt may be increased because the system may selectively incorporate elements of the signature to generate an image. In some current text-to-image models, the models have access to full images of an entity's signature, such as complete images of an entity's logo including specific fonts, colors and slogans. Because they are limited by the complete images they have access to, these models may force images relating to the entity into a generated image, even if the entity image does not align with the image generation prompt. For example, current text-to-image models may receive an image generation prompt to create an image for a product on a beach, with a serene aesthetic, and incorporating an entity's logo. The current text-to-image models may only have access to images of the entity's logo that do not align with the requested scene, such as bright colors and bold fonts. Following this scenario, the current text-to-image models may incorporate these unaligned signatures into the generated image. The technology described herein, allows for the text-to-image model to receive a similar prompt and selectively utilize signature elements that align with the prompt. For example, the text-to-image model described herein, would receive a similar prompt as input into the current text-to-image model, and be able to use the signature elements that align with the prompt, such as using the logo but changing the colors or font to match the requested aesthetics.

Further, by storing signature elements for specific entities, the system no longer has to store every possible iteration of an entity's signature, thus decreasing the memory and storage requirement of the system as compared to having to store every iteration of the entity's signature. For example, systems typically store as many iterations and/or variations of the entity's signature as possible. The iterations may be stored as images in pixel form. This requires a large amount of memory and/or storage. Having to parse through each iteration requires a large amount of processing power. By storing the signature elements, the need to store every iteration of an entity's signature is removed, thereby decreasing the memory and/or processing requirements of the system. The signatures incorporated into the generated images are generated on demand using the signature elements of the selected signature. To reduce the amount of storage required, the signatures generated on demand may not be stored by the system.

According to some examples, the use of signature elements may reduce the number of inputs required by the requester of a desired image. For example, if the request for a desired image includes the name of an entity, the system may be trained to generate a desired image based on the signature elements related to the entity without any additional inputs from the requestor. This increases the computational efficiency of the system by decreasing the amount of processing power and network overhead to produce the desired image. The amount of processing power may be decreased by not having to receive and process additional inputs from the requestor. Further, as the system is trained to provide a tailored image that is ready to be published, the computational efficiency of the system is increased as there is unlikely to be subsequent or repeat requests for additional images to be generated.

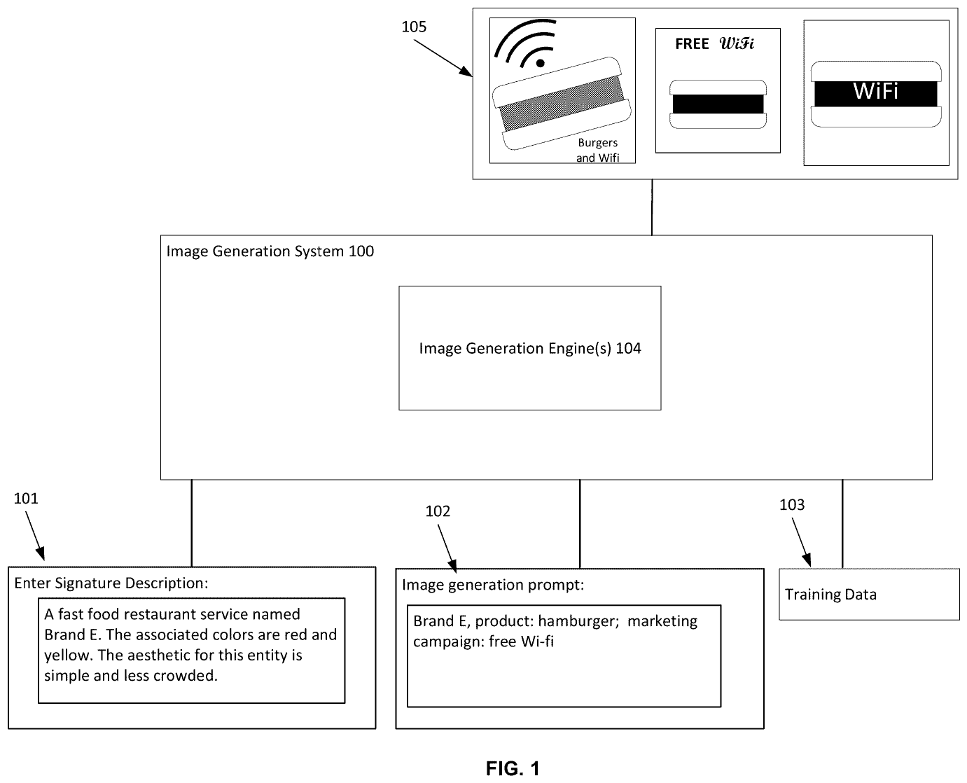

FIG. 1 illustrates an example image generation system 100. The image generation system 100 may, in some examples, be a machine learning model. Examples of machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backward propagation of errors. For example, a loss function can be backpropagated through the model(s) to update one or more parameters of the model(s) (e.g., based on a gradient of the loss function). Various loss functions can be used such as mean squared error, likelihood loss, cross-entropy loss, hinge loss, and/or various other loss functions. Gradient descent techniques can be used to iteratively update the parameters over a number of training iterations. A number of generalization techniques (e.g., weight decays, dropouts, etc.) can be used to improve the generalization capability of the models being trained.

The model(s) can be pre-trained before domain-specific alignment. For instance, a model can be pre-trained over a general corpus of training data and fine-tuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data and may be further updated or refined during their use based on additional feedback/inputs.

The image generation system 100 may be configured to receive inference data and/or training data for use in generating an image specific to an entity. For example, inference data and/or training data as part of a call to an application programming interface (API) exposing the image generation system 100 to one or more computing devices. Inference data and/or training data can also be provided to the image generation system 100 through a storage medium, such as remote storage connected to one or more computing devices over a network. Inference data and/or training data can further be provided as input through a user interface on a client computing device coupled to the image generation system 100.

The inference data can include data associated with signature descriptions 101 and image generation prompts 102. For example, the image generation system 100 may receive signature descriptions 101 as inputs. In some examples, the signature may be associated with one entity. The entity may be a content creator, an advertiser, an artist, an individual, etc. The image generation system 100 may derive signature elements from the signature description 101. The signature elements may include features of an entity's brand such as name, logo, product, services, colors, fonts, target audience, target geographic region, aesthetics, slogans, or the like. The signature elements may be provided as input or generated by AI techniques. The signature elements may be organized by the system into a signature registry. According to some examples, the signature descriptions 101 may be received as input provided by a signature creator.

The image generation prompt 102 may include the signature or the name of the entity associated with the signature. The image generation prompt 102 may also include specifications of the desired image. For example, the image generation prompt 102 may include a description of the brand, product, intended purpose of the digital content, or the like.

According to some examples, the entity may provide the signature descriptions 101 and/or image generation prompts 102 as input into the image generation system 100. For example, a representative of the entity may provide the signature descriptions 101 and/or image generation prompts 102 as input into a user interface. The representative providing the inputs for the signature descriptions 101 may be the representative providing the inputs for the image generation prompts 102. In some examples, the representative providing the inputs for the signature descriptions 101 and the representative providing the inputs for the image generation prompts 102 may be different. In other examples, the entity providing the signature descriptions 101 may be the same or different than the entity providing the image generation prompts 102.

The training data 103 can be in any form suitable for training a model, according to one of a variety of different learning techniques. Learning techniques for training a model can include supervised learning, unsupervised learning, and semi-supervised learning techniques. For example, the training data 103 can include multiple training examples that can be received as input by a model. The training examples can be labeled with a desired output for the model when processing the labeled training examples. The label and the model output can be evaluated through a loss function to determine an error, which can be back-propagated through the model to update data for the model. For example, if the machine learning task is a classification task, the training examples can be images labeled with one or more classes categorizing subjects depicted in the images. As another example, a supervised learning technique can be applied to calculate an error between outputs, with a ground-truth label of a training example processed by the model. Any of a variety of loss or error functions appropriate for the type of task the model is being trained for can be utilized, such as cross-entropy loss for classification tasks, or mean square error for regression tasks. The gradient of the error with respect to the different weights of the candidate model on candidate hardware can be calculated, for example using a backpropagation algorithm, and the weights for the model can be updated. The model can be trained until stopping criteria are met, such as a number of iterations for training, a maximum period of time, a convergence, or when a minimum accuracy threshold is met.

According to some examples, the training data 103 can correspond to an artificial intelligence (“AI”) task, such as a machine learning (“ML”) task, for generating images based on textual or verbal input cues, such as a task performed by a neural network. The training data 103 can also correspond to AI or ML tasks for deciphering a signature of an entity. The training data 103 can be in any form suitable for training a model, according to one of a variety of different learning techniques. Learning techniques for training a model can include supervised learning, unsupervised learning, and semi-supervised learning techniques.

From the inference data, e.g., the signature description 101 and image generation prompt 102, and the training data 103, the image generation system 100 can be configured to output one or more results related to a generated image 105 and/or generated digital content. As an example, the output data can be any kind of image, digital content, or the like output based on the input data. Correspondingly, the AI or ML task can be a scoring, classification, and/or regression task for predicting some output given some input. These AI or ML tasks can correspond to a variety of different applications in processing images, video, text, speech, or other types of data to generate images or digital content.

As an example, the image generation system 100 can be configured to send the output data for display on a client or user display. As another example, the image generation system 100 can be configured to provide the output data as a set of computer-readable instructions, such as one or more computer programs. The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement the functionality described herein, for example, as performed by a system, engine, module, or model. The image generation system 100 can further be configured to forward the output data to one or more other devices configured for translating the output data into an executable program written in a computer programming language. The image generation system 100 can also be configured to send the output data to a storage device for storage and later retrieval.

The image generation system 100 can include one or more image generation engines 104. The image generation engines can be implemented as one or more computer programs, specially configured electronic circuitry or any combination thereof. The image generation engines 104 may be configured to determine the signature elements based on the signature description 101 provided as input. The image generation engines 104 may be configured to determine, based on the image generation prompts 102, which signature elements to incorporate into the generated images 105.

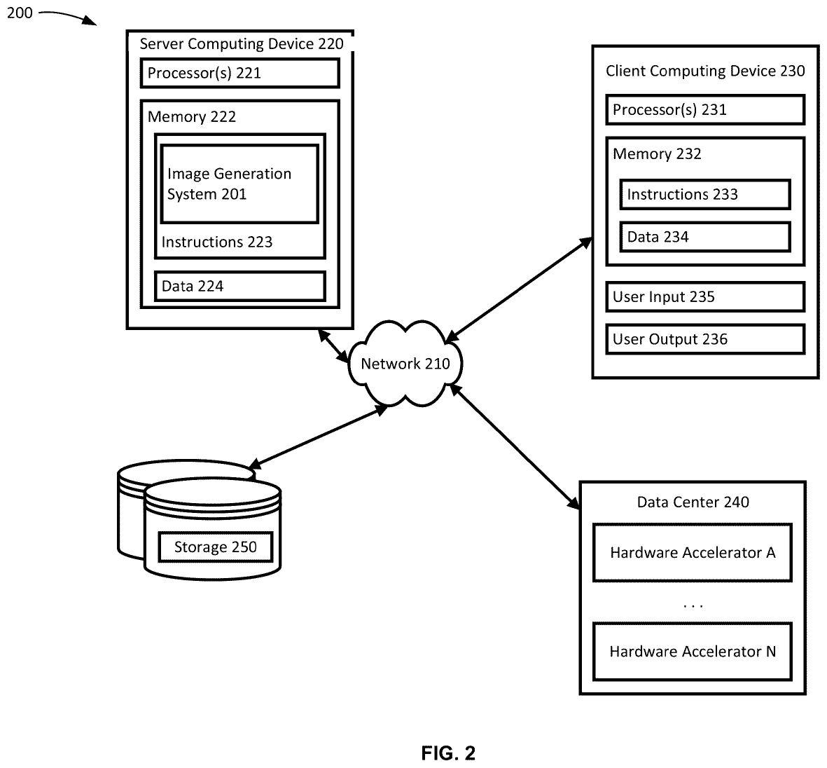

FIG. 2 depicts a block diagram of an example environment 200 for implementing an image generation system 201. The environment includes a server computing device 220, client computing device 230, and storage 250 connected over network 210.

The image generation system 201 can be implemented on one or more devices having one or more processors in one or more locations, such as in a server computing device. Client computing device 230 and the server computing device 220 can be communicatively coupled to one or more storage devices over a network 210. The storage devices can be a combination of volatile and non-volatile memory and can be at the same or different physical locations than the computing devices. For example, the storage devices can include any type of computer-readable medium capable of storing information which may be non-transitory, such as a hard drive, solid-state drive, tape drive, optical storage, memory card, ROM, RAM, DVD, CD-ROM, write-capable, and read-only memories.

The server computing device 220 can include one or more processors 221 and memory 222. The memory 222 can store information accessible by the processors 221, including instructions 223 that can be executed by the processors 221. The memory 222 can also include data 224 that can be retrieved, manipulated, or stored by the processors. The memory 222 can be a type of computer-readable medium which may be non-transitory and capable of storing information accessible by the processors 221, such as volatile and non-volatile memory. The processors can include one or more central processing units (CPUs), graphic processing units (GPUs), field-programmable gate arrays (FPGAs), and/or application-specific integrated circuits (ASICs), such as tensor processing units (TPUs).

The instructions 223 can include one or more instructions that, when executed by the processors 221, cause the one or more processors 221 to perform actions defined by the instructions 223. The instructions 223 can be stored in object code format for direct processing by the processors 221, or in other formats including interpretable scripts or collections of independent source code modules that are interpreted on demand or compiled in advance. The instructions 223 can include instructions for implementing the image generation system 201. The image generation system 201 can be executed using the processors 221, and/or using other processors remotely located from the server computing device 220.

The data 224 can be retrieved, stored, or modified by the processors 221 in accordance with the instructions 223. The data can be stored in computer registers, in a relational or non-relational database as a table having a plurality of different fields and records, or as JSON, YAML, proto, or XML documents. The data 224 can also be formatted in a computer-readable format such as, but not limited to, binary values, ASCII, or Unicode. Moreover, the data 224 can include information sufficient to identify relevant information, such as numbers, descriptive text, proprietary codes, pointers, references to data stored in other memories, including other network locations, or information that is used by a function to calculate relevant data.

According to some examples, server computing device 220 may be a digital content server. The digital content server may manage content, such as digital components, and provide various services to the merchants, publishers, and devices 230. According to some examples, the digital content server may receive digital component campaigns from one or more merchants or entities, such as advertisers. The digital component campaigns may include campaign information, such as the bidding strategy, conversion values, targeting information, duration, etc. In some examples, the digital content server may receive a request to generate digital content. In such an example, the image generation system 201 may generate images and/or digital content responsive to the request. The generated images and/or digital content may be stored in the memory 222 of the digital content server, provided as output to the client computing device 230, stored in storage 250, or the like.

The client computing device 230 can also be configured similarly to the server computing device 220, with one or more processors 231, memory 232, instructions 233, and data 234. The client computing device 230 can also include a user input 235 and a user output 236. The user input 235 can include any appropriate mechanism or technique for receiving input from a user, such as a keyboard, mouse, mechanical actuators, soft actuators, touchscreens, microphones, and sensors.

Outputs 236 may be a display, such as a monitor having a screen, a touchscreen, a projector, or a television. The outputs 236, e.g., a display of the device 230, may electronically display information to a user via a graphical user interface (“GUI”) or other types of user interfaces. For example, the display may electronically display the generated image and/or digital content. In some examples, the server computing device 220 can be configured to transmit data to the client computing device 230, and the client computing device 230 can be configured to display at least a portion of the received data on a display implemented as part of the user output 236. The user output 236 can also be used for displaying an interface between the client computing device 230 and the server computing device 220. The user output 236 can alternatively or additionally include one or more speakers, transducers, or other audio outputs, a haptic interface, or other tactile feedback that provides non-visual and non-audible information to the platform user of the client computing device 230.

Although a single device 230 is depicted, it should be appreciated that a typical system can include one or more client computing devices 230, with each computing device being at a different node of network 210. The devices may be capable of directly and indirectly communicating with other nodes of network 210.

Although FIG. 2 illustrates the processors and the memories as being within the computing devices, components described herein can include multiple processors and memories that can operate in different physical locations and not within the same computing device. For example, some of the instructions 223, 233 and the data 224, 234 can be stored on a removable SD card and others within a read-only computer chip. Some or all of the instructions 223, 233 and data 224, 234 can be stored in a location physically remote from, yet still accessible by, the processors 221, 231. Similarly, the processors 221, 231 can include a collection of processors that can perform concurrent and/or sequential operations. The computing devices 220, 230 can each include one or more internal clocks providing timing information, which can be used for time measurement for operations and programs run by the computing devices.

The server computing device 220 can be connected over the network 210 to a data center 240 housing any number of hardware accelerators. The data center 240 can be one of multiple data centers or other facilities in which various types of computing devices, such as hardware accelerators, are located. Computing resources housed in the data center 240 can be specified for deploying models related to generating images based on text or verbal input cues as described herein.

The server computing device 220 can be configured to receive requests to process data from the client computing device 230. According to some examples, the server computing device may be configured to process data on computing resources in the data center 240. For example, the environment can be part of a computing platform configured to provide a variety of services to users, through various user interfaces and/or application programming interfaces (APIs) exposing the platform services. The variety of services can include generating images based on text or verbal input cues. The client computing device 230 can transmit input data, such as textual or verbal input cues. The image generation system 201 can receive the input data, and in response, generate output data including an image including an object, such as a product for advertisement with background imagery corresponding to the textual or verbal input cues.

As other examples of potential services provided by a platform implementing the environment 200, the server computing device 220 can maintain a variety of models in accordance with different constraints available at the data center 240. For example, the server computing device 220 can maintain different families for deploying models on various types of TPUs and/or GPUs housed in the data center or otherwise available for processing.

### A. Signatures

A signature may be a semi-structured set of data, composed with multimodal inputs. In some examples, a signature may relate to an entity, merchant, or business. For example, the signature may be a logo, color themes, taglines, catchphrase, evolving marketing values, or the like. Evolving marketing values may be, for example, climate-conscious, locally owned, green-certified, carbon neutral, etc. In some examples, the signature may relate to a style for a content creator, such as styling elements, layouts, emotional effects, or the like. Emotional effects may include, for example, chirpy, somber, etc. In some examples, the signature may relate to an artist, such as the signature style of the artist, and the use of particular tones or shapes, etc. In some examples, the signature may be applied to other domains, such as to the tradition or culture of the target viewers or target event.

A signature may relate to the identity of an entity, merchant, business, or the like. In some examples, the entity may be a content creator. The content creator may be an advertiser. By defining a signature, an entity has a unique capability to produce images that speak to the entity and are specific to the entity. A signature may be made of signature elements.

Signature elements may include information about the entity, such as name, logo (i.e., shape, symbols, layouts), colors, fonts, values, marketing emotion, marketing message, tagline, desired landing page, etc. The signature elements may also include attributes specific to the entity, such as being lightweight, fast, futuristic, refreshing, adventurous, energizing, healthy, relaxing, delicious, smooth, etc. In some examples, the signature elements may further include target viewers, such as intended geographic location, language, culture, age, or the like. In some examples, the signature elements may further include creativity specifications, such as direct language, meaning literal, simple, straightforward, or minimalist style, or, in contrast, indirect language, meaning innovative or creative use of language. In some examples, the signature elements may further include desired aesthetics of the content, such as whether the images should be close up, more or less crowded, picturesque, etc.

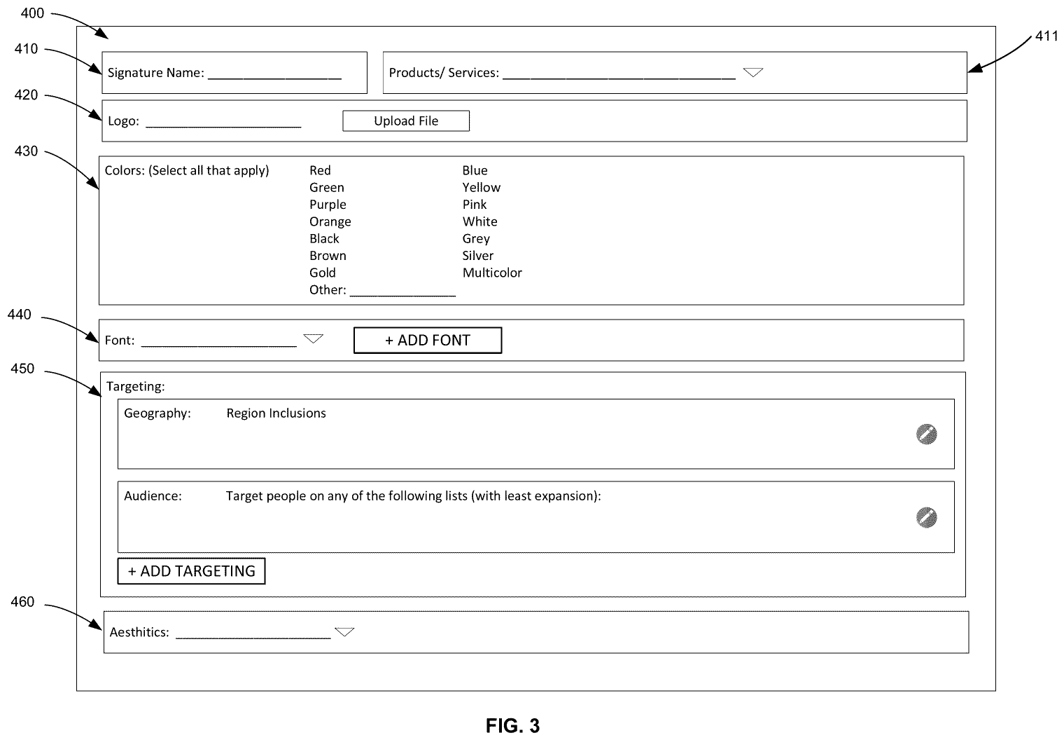

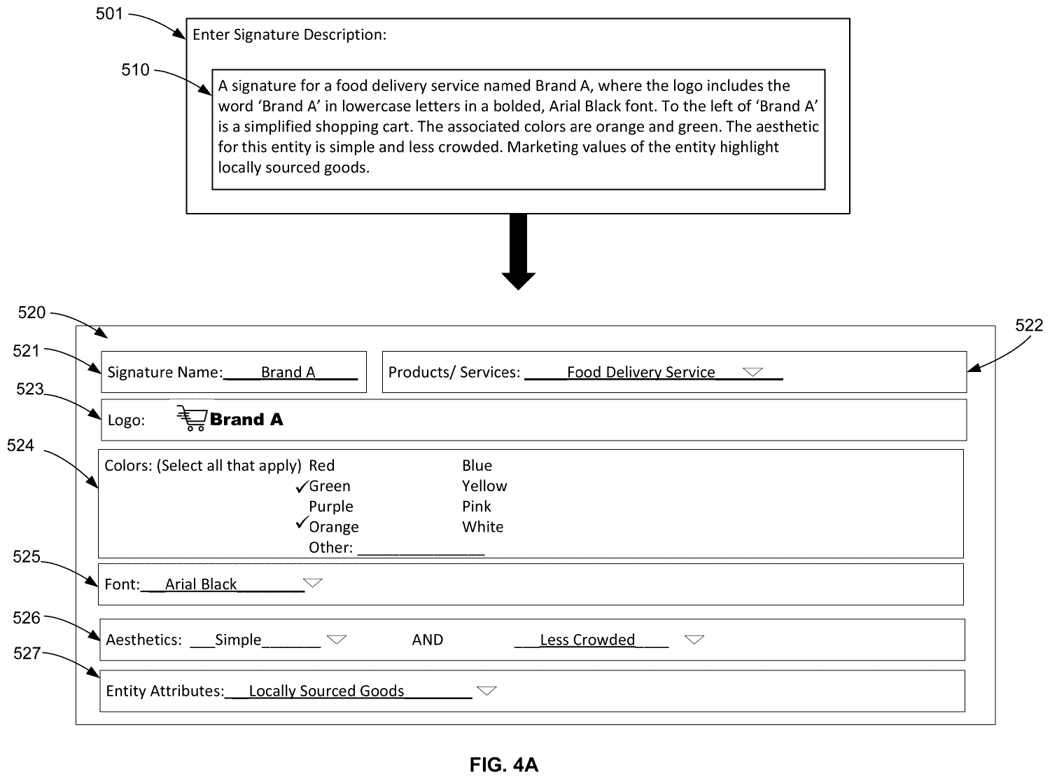

FIG. 3 depicts an example user interface 400 for generating a signature for an entity. The user interface 400 may include one or more input fields. The inputs provided into the user interface 400 may be provided as inputs into the image generation system 100 of FIG. 1. In some examples, the inputs may be provided into the image generation engine 104 of FIG. 1 to generate an image based on the signature. The input fields may correspond to signature elements of the signature. The input fields may be configured to receive details associated with the entity specifically relating to the signature name 410, products/services 411, logo 420, colors 430, font 440, targeting options 450, and aesthetics 460. The interface 400 may include additional input fields not shown, such as marketing emotion, marketing message, tagline, catchphrase, entity attributes to highlight, etc.

The signature name 410 may allow for the signature creator to name the signature. The name of the signature may mirror the name of the entity or may contain additional information to distinguish it from similar logos within the entity's portfolio. For example, the signature creator may name a signature directly after the entity, such as Brand X. In some examples, an entity may have multiple signatures, such as a simple signature and a complex logo. The signature may distinguish between the signatures by naming the signatures “Simple Signature” and “Complex Signature,” respectively.

In some examples, the signature name 410 may be used internally by the signature creator to track content or images that have been generated with the signature. The system may receive the signature name via inputs from a keyboard, microphone, touchscreen, etc.

The products/services 411 may be products or services associated with the entity and/or the signature. The product/services 411 may be entered by the signature creator. For example, the entity may sell athletic equipment and enter “sporting goods” as their product.

The logo 420 may allow for the signature creator to upload an image of an entity logo. The logo may be uploaded as any suitable image file, such as a jpeg, png, bmp, etc.

Colors 430 may allow for the signature creator to select particular colors associated with the entity and the signature. The colors 430 may be from the logo or the overall entity aesthetics. The selected colors may be incorporated into generated images or content. For example, if red and blue are selected, the system may use red and blue as background colors or font colors for any wording according to the signature parameters.

Font 440 may allow the signature creator to select the font to be used for any wording in the generated images. In some examples, the font 440 may mirror the font within the logo or be different from the logo.

Targeting options 450 may allow the signature creator to select specific geographic regions or specific audiences the generated content should be directed towards. The signature may incorporate these selections into generated content. For example, if a signature is to be directed towards users within the New York City metropolitan area, the generative AI may use this information to include benefits specific to that region, such as case of a product's use on a subway or in a taxi.

Aesthetics 460 may allow for the signature creator to select desired aesthetics of the content, such as whether the images should be close up, more or less crowded, or picturesque. The aesthetics 460 may be inputted from a drop-down menu, as depicted on the user interface 400 of FIG. 3. In some examples, the user interface may allow for the signature creator to enter the desired aesthetics through written descriptions or image examples.

i. Signature Elements Derived from Language and Visual Models

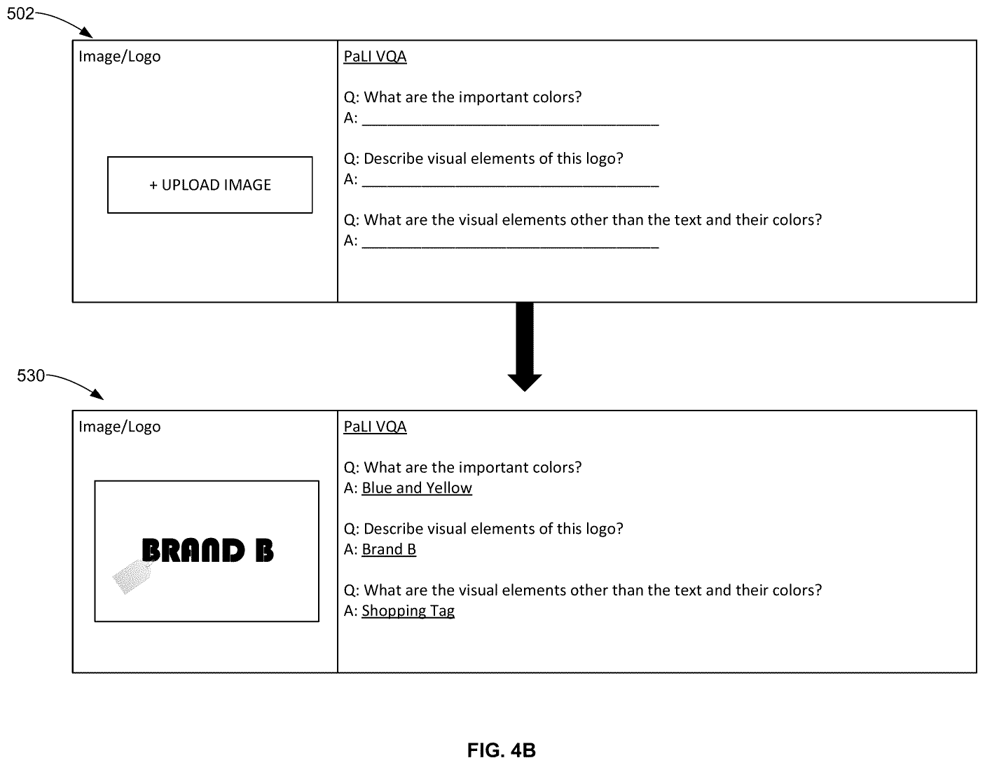

FIG. 4A depicts an example user interface 501 for creating a signature for an entity wherein the signature elements are derived from language models. User interface 501 can be displayed on a user device. User interface 501 may include a text box 510 or any other input for a signature creator to provide a textual description of the signature of an entity. The textual description may include an entity's signature elements.

In text box 510, a signature creator may textually describe a signature for an entity as “A signature for a food delivery service named Brand A, where the logo includes the word ‘Brand A’ in lowercase letters in a bolded, Arial Black font. To the left of ‘Brand A’ is a simplified shopping cart. The associated colors are orange and green. The aesthetic of this entity is simple and less crowded. Marketing values of the entity highlight locally sourced goods.” As depicted in FIG. 4A, the image generation system may derive the following signature elements from the user textual description of text box 510: “Brand A,” food delivery service, simplified shopping cart, orange, and green, simple, less crowded, and locally sourced goods.

The signature description may be provided as input into the image generation system 100 and/or image generation engine 104. The image generation system 100 may use the textual description of the entity's signature to discern one or more signature elements. An entity's signature elements may be derived from language models, such as PaLI, GPT, GLaM, PaLM, and T5. In some examples, the system may internally populate signature elements from the textual description into a signature registry 520. The system may populate the signature registry 520 with signature elements, such as signature name 521, products/services 522, logo 523, colors 524, font 525, aesthetics 526, entity attributes 527, etc.

In some examples, these language models may be a scalable multimodal and multilingual model designed for solving a variety of vision-language tasks. In some examples, the language model may use a textual description of the logo to determine signature elements. For example, the user may input a paragraph describing the colors, shapes and words associated with the logo and general styling elements to be included with the entity.

FIG. 4B depicts an alternative example, user interface 502 for generating a signature for an entity. According to some examples, signature elements related to the signature may be derived from language models. User interface 502 may be provided for output on a user device, such as a display of client computing device 230.

User interface 502 may include specific inquiries to be answered by a signature creator. In some examples, the user interface 502 may present inquiries or prompts to the signature creator that relate to the signature elements of the entity. For example, the system may provide prompts such as “What are the important colors,” “Describe visual elements of this logo,” and “What are the visual elements other than text and their colors.”

As depicted in completed user interface 530, a signature creator may respond to these prompts with information regarding the entity such as “blue and yellow” as important colors of the logo/entity, “Brand B” as the visual elements of the logo, and a “shopping tag” as a visual element besides the text. The information inputted in the user interface 530 may be used by the system to internally create a signature register.

In some examples, the system may also receive images of the entity's logo or related images to include with the signature. The images may be provided as input into one or more machine learning models, such as a vision model. The vision model may interpret, or derive, a visual representation of signature elements of an entity based on the received input. The visual representation may be, for example, an image of the logo, fonts used in the logo, and colors associated with the entity. In some examples, the language and visual models may be one model.

A signature creator may rank the signature elements in order of importance. The order of importance may be provided as input into the image generation system. According to some examples, the output of the image generation system may be based on the ranked signature elements. The output of the image generation system may, additionally or alternatively, be based on the prompts included in the signature. For example, a signature creator may place the highest level of importance on the entity's logo and the lowest level of importance on the entity attributes. When the image generation system 100 receives an image generation request or prompt to generate the signature of the entity, the image generation system 100 may prioritize generating an image and/or digital content with the entity's logo over other signature elements and may, in some examples, forgo the inclusion of the entity's attributes.

In some examples, the image generation system may automatically rank the signature elements in order of importance. The image generation system may use data from previously generated images using the entity's signature to rank the signature elements. The image generation system may determine from the generated images selected by users under the entity's signature that one signature element is more important than another in the users' choice of images. For example, users who request images including the signature related to Brand B choose generated images that include the entity's colors but not the additional visual element, the system may rank the colors higher than the additional visual element.

ii. Signature Elements Derived from AI Techniques.

In some examples, an entity's signature elements may be derived using AI techniques and search engine databases. The signature elements may be determined using aggregate information about a selected entity found on a search engine. For example, a Web Rendering Service (“WRS”) could be used to obtain a Document Object Model (“DOM”) tree of the webpage to help extract a list of design elements such as headers, divisions, paragraphs, etc. From the Cascading Style Sheets (“CSS”) computer language attributes of these design elements, the system may extract a list of attributes, for example, colors, present in the webpage. Further, the system may score and rank those attributes using various signals, such as the color's frequency, the occupancies of their associated design elements, etc. Other AI techniques such as object detection could be used to detect entities in images. In some examples, a segmentation model can be leveraged to identify key headings, images, and text content from web pages. The information derived using AI techniques may be used by the system to internally generate a signature registry for an entity.

B. Incorporating Signature into Image Generation Models

In response to receiving a request to generate an image, the image generation system may generate a production-ready image and/or digital content, without further input from the entity. The request may be provided as input by the entity or a user not affiliated with an entity. For example, the user may enter a prompt and an image may be generated using one or more signatures previously created by the entities. The image generated by the image generation system may provide flexibility in creating an image tailored to the signature of the entity based on signature elements previously provided by the entity and/or determined by the image generation system. The signature elements allow for the image generation system to accurately generate an image in response to the request, which may include one or more elements to include in the generated image. For example, if the request, or generation prompt, includes the name of the entity, the image generation system may be trained to provide a tailored image based on the signature registry relating to the entity. By way of the previously ranked signature elements, the generated image is produced with an increased likelihood of being a desired image by the requestor. This increases computational efficiency in two ways, firstly by reducing the number of inputs per image required by the entity to produce a desired image which decreases the amount of processing and network overhead associated with the reduced number of inputs to produce an image, and secondly, an increased likelihood of an individual image being desired means that repeat generation of further images is reduced which saves both further inputs, and the network and processor overhead associated with providing an image to the requestor, to subsequently be undesired, and a repeat request and image generation needing to be made. As can be seen, technical real-world benefits are realized by way of efficiently selecting components to form a newly generated image.

i. Signature Elements Use in Text-to-Image Generative Models

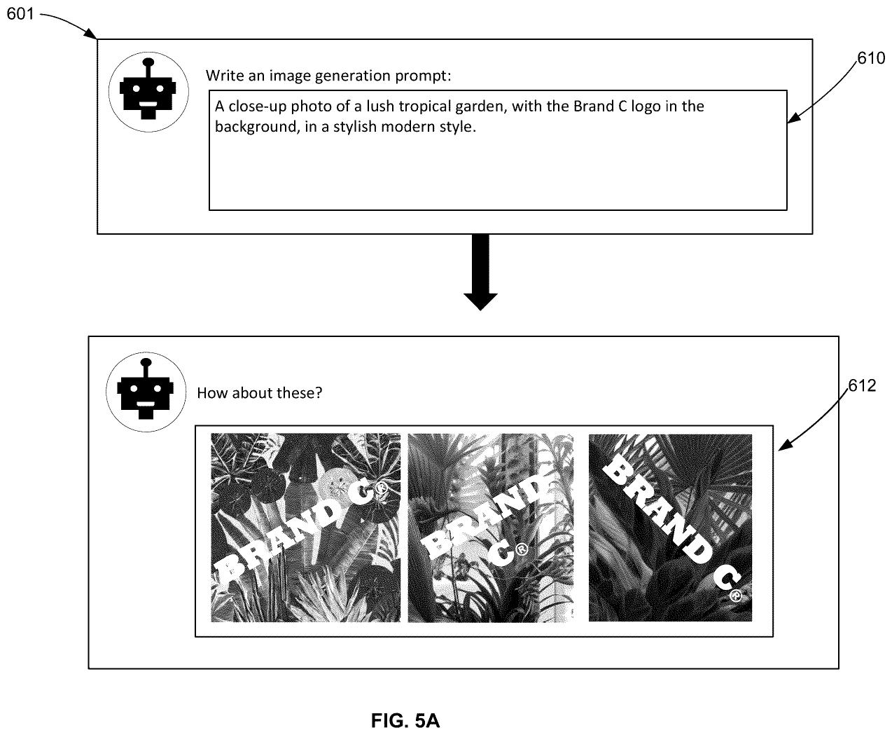

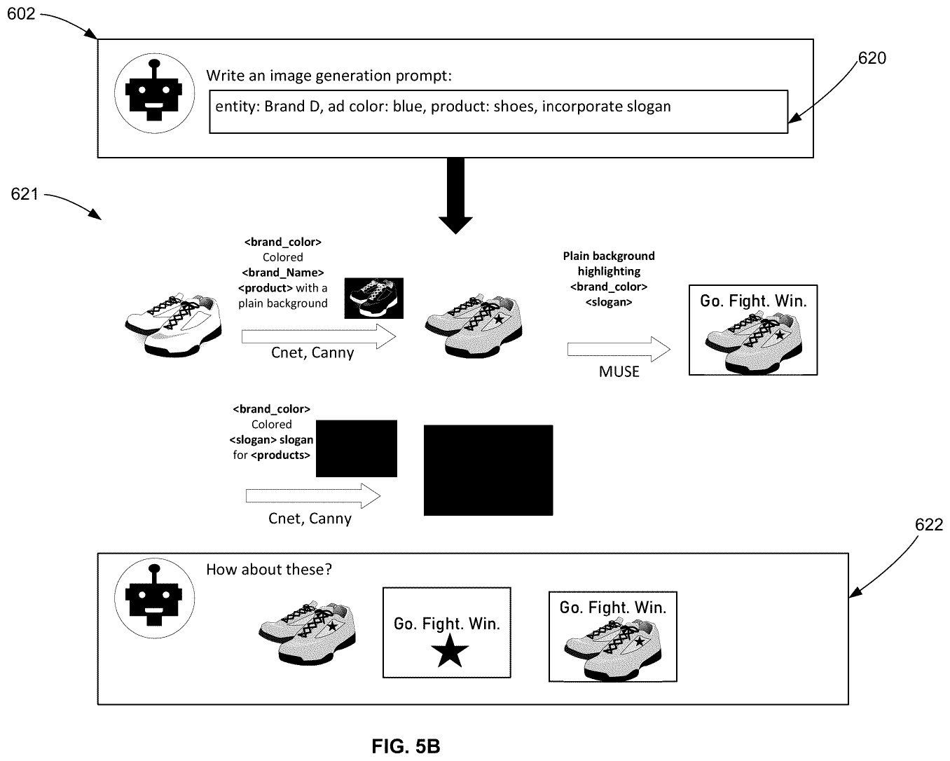

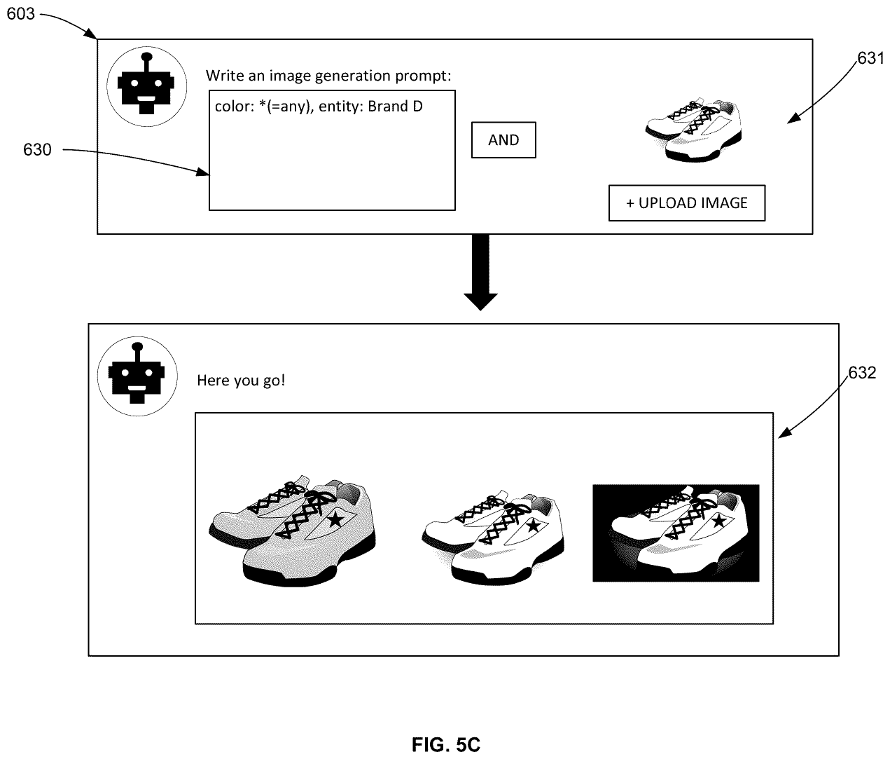

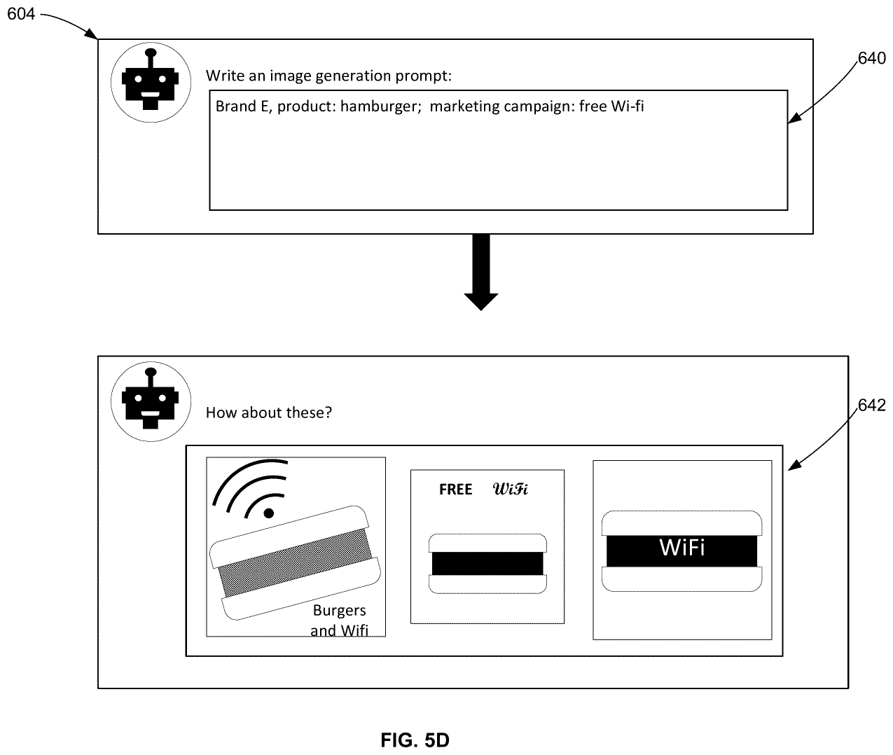

FIG. 5A depicts an example of the text-to-image generation model trained to generate an image based on a signature. A user interface 601 may be displayed on a user device, such as a laptop, mobile phone, tablet, etc. The user interface 601 may include a prompt box 610. The prompt box 610 may be configured to receive inputs, such as an image generation request.

The prompt box 610 may receive instructions for an image to be generated by the image generation system. For example, an image generation prompt may be provided, via prompt box 610, into a generative AI bot. The image generation prompt, as shown, is “A close-up photo of flowers, with the Brand C logo in the background, in a stylish modern style.” In this example, a signature registry may have already been created for Brand C according to at least one of the methods described above. The text-to-image generative model, e.g., image generation engine 104, may receive the prompt as input and use the signature registry regarding “Brand C,” specifically signature elements such as white and green colors, block lettering, diagonal writing and ® in the corner of the logo to generate an output.

The system may determine which of these signature elements are more compatible with the specifications of image generation prompt or would be better suited to respond to the image generation prompt. This determination may be based on the image generation prompt, a signature creator's ranking of signature elements, the system's ranking of the signature elements, typical use of signature elements of the entity or similar entities, etc. For example, the system may select to use the logo of Brand C in response to the image generation prompt, as it is specifically asked for in the prompt. Further, the system may forgo the use of the brand's traditional color scheme of green and black if it clashes with the “lush tropical garden.”

In response to the prompt in prompt box 610, the system may provide as output one or more images. The generated images may include the Brand C logo behind a lush tropical garden, as shown in response box 612. In some examples, the system may only generate one image at a time. The AI bot may use conversational language when presenting the generated images, such as “How about these?” or “What do you think of these?”. According to some examples, the generated images provided as output may be selectable images, downloadable images, or the like.

FIG. 5B depicts another example of the text-to-image generation model trained to generate an image based on a signature. A user interface 602 may be displayed on a user device, such as a laptop, mobile phone, tablet, etc. The user interface 602 may include a prompt box 620. The prompt box 620 may be configured to receive inputs, such as an image generation request.

In some examples, the user may enter basic prompts into a text-to-image generative model to create custom image outputs. In this example, a signature registry for Brand D has already been created according to at least one of the methods described above. For this example, the signature registry includes signature elements for Brand D, including logo: black star, color: blue and gray, slogan: ‘Go. Fight. Win.’ and style: athletic and simple. Next, an image generation prompt may be provided via prompt box 620. The image generation prompt, as shown, is “entity: Brand D, ad color: blue, product: shoes, incorporate slogan.”

As shown in process 621, the disclosed technology may utilize one or more text-to-image generation models, e.g., image generation engine 104, such as ControlNet, ContourNet, Canny, MUSE, etc., to create custom image outputs based on the text inputs in the prompt box 610. In some examples, product outlines or images may be used to generate new images.

The image generation model may recognize Brand D and incorporate the signature elements of the signature registry into generating images based on the specifications of the image generation request, as shown in response box 622. In generating the images, the system may use all or less than all of the signature elements for each image. For example, the system may use the entity's logo in some but not all of the generated images.

ii. Signature Elements Use in Image Editing Models

FIG. 5C depicts an example of an image editing model configured to generate an image based on a signature. A user interface 603 may be displayed on a user device, such as a laptop, mobile phone, tablet, etc. The user interface 603 may include a prompt box 630 and a starting image input 631. The prompt box 630 may be configured to receive inputs, such as an image generation request.

In some examples, the image generation system may utilize image editing models wherein the model may incorporate signature elements into an already existing image. The image generation system may be configured to receive an image. The system may utilize an image editing model and an entity signature to modify the uploaded image. In this example, a signature registry for Brand D has already been created according to at least one of the methods described above. In this example, the signature registry includes signature elements for Brand D, including logo: black star, color: white, slogan: ‘Go. Fight. Win.,’ and style: athletic and simple. Next, an image of an athletic shoe may be uploaded into the starting image input 631 with the prompt in prompt box 630 “color: * (=any), entity: Brand D.” The image editor model may recognize Brand D and incorporate the signature elements from the signature registry into the uploaded image based on the specifications of the user prompt.

The image generation model may recognize Brand D and incorporate the signature elements of the signature registry into generating images based on the specifications of the user prompt, as shown in response box 632. In generating the images, the image generation system may use all or less than all of the signature elements for each image. In some examples, the system may generate a dynamic file in response to the prompt. For example, the image generation system may generate a gif. file and display in response box 632, wherein the gif. file changes colors but keeps the starting image the same.

iii. Specifying Marketing Messages in Image Generation Prompts

FIG. 5D depicts an example of the text-to-image generation model, e.g., image generation engine 104, trained to generate an image based on a signature and a marketing message. A user interface 604 may be displayed on a user device, such as a laptop, mobile phone, tablet, etc. The user interface 604 may include a prompt box 640. The prompt box 640 may be configured to receive inputs, such as an image generation request or marketing message.

In some examples, the image generation system may be configured to receive a marketing message in the prompt box 640. The marketing message may be an extension of the signature elements of an entity. In this example, a signature registry for Brand E has already been created according to at least one of the methods described above. In this example, the signature registry may have signature elements of Brand E, including logo: bolded “E,’ color: red and yellow, slogan: “It's good food,” style: bold and energetic. Next, a user may input into prompt box 640 “entity: Brand E, product: hamburger, marketing campaign: free wi-fi.”

The image generation system may recognize Brand E and incorporate the signature elements from the signature registry into generating the image based on the specifications of the user input, highlighting the marketing campaign. The generated images may be displayed in response box 642. The image generation system may depict the campaign using graphics that relate to the prompt. For example, to depict ‘free Wi-Fi,” the system may use the words “free Wi-Fi,” a radar symbol, or just “Wi-Fi” by itself.

In some examples, the image generation system may be further configured to utilize an image editor to modify images from previous marketing campaigns to create updated content with the new marketing campaigns incorporated.

The systems and methods described herein may be used to reinforce entity-specific, signature elements in the text-to-image generation such that it preserves fine-grained details and style and simultaneously blends well with the generated image. In some examples, an entity may control the level of integration the text-to-image generation utilizes to preserve the signature elements. Depending on the importance of such an integration, entities and digital content creators may control the preservation of the signature elements by marking the signatures with three modes, in addition to the usual text prompt, high-precision, medium-precision, and low-precision. By selecting a particular mode, an entity is able to customize images that preserve fine-grained details of the signature.

For signatures marked as high-precision, during text-to-image generation, the image generation model may add all of the signature elements of the signature in the noise vector at every denoising time step. In some examples of the high-precision mode, the model may incorporate more than half of the signature elements of a signature.

For signatures marked as medium-precision, during text-to-image generation, the image generation model may use image processing tools, such as canny edges and controlNet, such that the model preserves the high-level elements in the generated image, but may change or not include low-level elements. This model may be similar to the example model described in connection with FIG. 5B. In some examples, high-level elements may be signature elements flagged as the most recognizable elements for the entity, such as the logo, brand colors, or slogans. Low-level elements may be signature elements flagged as less integral to the overall image of the entity, such as entity colors, preferred fonts, or aesthetics. In some examples, the elements may be flagged by the entity in a user interface when generating the signature profile. In some examples, the elements may be flagged by the model using prior data from other signatures. For example, the model may store information that logos and slogans are often flagged as high-level elements and fonts or aesthetics are often flagged as low-level elements. In some examples, the model may use information regarding which elements are included in the chosen generated images by the entities to inform which elements are high-level and low-level elements. For example, the model may store what images are ultimately chosen by an entity and determine the logo is included in all of the selected images. The model may flag a logo as a high-level element. Under the medium-precision mode, the model may sacrifice low-level elements for the overall presentation of the generated image.

For signatures marked as low-precision, the image generation model may not be conditioned to integrate the signature elements of the signature specifically. But rather, with low-precision signatures, the model may loosely incorporate signature elements that match the overall theme of the generated image based on the text prompt. For example, if an entity is looking to generate an image incorporating a signature that highlights a charitable cause, the entity may mark the signature as low-precision. This allows the model to highlight the charitable cause rather than the signature in the generated image, such that the signature elements are not the principal element of the generated image.

iv. Specifying Emotions in Image Generation Prompts

In some examples, the technology may allow a user to further specify an emotion to be conveyed by the ad in the prompt. The target emotion may be an extension of the signature elements of an entity. For example, a user may set signature elements for Brand D, including logo: checkmark, color: white, slogan: ‘better than the others,’ and style: athletic and simple. Next, the user may input a text-to-image generation model {entity: Brand D, target emotion: excitement, product: shoes}. The text-to image generation model may recognize Brand D and incorporate the signature elements into generating the image based on the specifications of the user input. In response to the target emotion, excitement, the model may generate an image that includes brighter colors with higher contrast and movement.

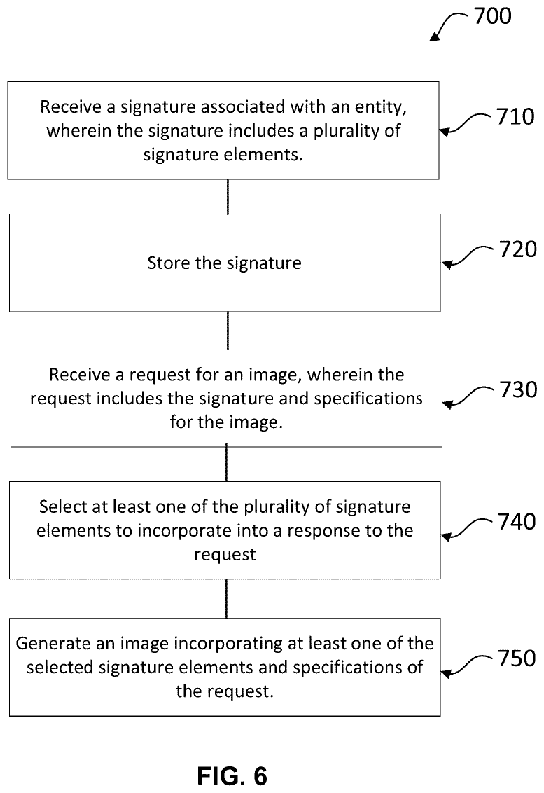

FIG. 6 illustrates an example method 700 for generating production-ready images incorporating entity signatures. The following operations do not have to be performed in the precise order described below. Rather, various operations can be handled in a different order or simultaneously, and operations may be added or omitted.

In block 710, an image generation system may receive a signature associated with an entity, wherein the signature includes a plurality of signature elements. The signature may be a semi-structured set of data composed of multimodal inputs. The signature may further be defined from inputs from a user. In some examples, the signature may be defined from inputs from AI techniques. The signature elements may be features of an entity's brand such as entity name, logo, product, services, colors, fonts, target audience, target geographic region, aesthetics, slogans, visual elements of the logo, and attributes of the entity. The signature elements may be inputted by a signature creator or generated by AI techniques. The signature elements may be organized by the system into a signature registry. In some examples, the signature elements may be ranked by the signature creator or the system.

In block 720, the system may store the signature. The system may store the signature elements in a signature registry. The system may store the signature elements internally or externally.

In block 730, the system may receive a request for an image, wherein the request includes the signature and specifications for the image. The system may have a user interface to receive image requests from users. The request may include the name of the entity for which a signature is related, or the name given to a signature registry. The request may also include a description of additional specifications to be included in the image beyond the signature. The request may further include a marketing message. The request may further incorporate at least one target emotion.

In block 740, the system may select at least one of the plurality of signature elements to incorporate into a response to the request. The system may incorporate less than all of the signature elements into the response to the request. The system may incorporate all of the signature elements into the response to the request. In some examples, the system may determine which of the signature elements to incorporate into the response based on the request. For example, the system may determine which of the plurality of signature elements is compatible with the specifications of the request.

The signature elements may be ranked by level of importance. In some examples, the system may determine which of the signature elements to incorporate into the response based on a ranking of the signature elements.

In block 750, the system may generate an image incorporating at least one of the selected signature elements and specifications of the request. The system may generate more than one image in response to the request.

The method allows for reduced storage at the image generation system and increased accuracy while maintaining flexibility in generating images and content related to specific entities. The method can more efficiently respond to an image generation prompt that includes a specific entity name by using the information from a signature registry. The systems and methods described herein increase the computational efficiency by reducing the amount of memory, storage, and/or processing required to generate a desired image. For example, by storing signature elements for specific entities, the image generation system no longer has to store every possible iteration of an entity's signature. This reduces the amount of memory and storage required to generate accurate images in response to the image generation prompts. Further, by using signature elements to generate a desired input in response to a request, the generated image is produced with an increased likelihood that the generated image is desired, or approved, by the requestor. This increased the computational efficiency by reducing the number of inputs per generated image. Further, the amount of processing and network overhead is decreased due to the decreased number of inputs. Moreover, by using signature elements to generate a desired image, the number of requests to generate an image that is likely to be accepted by the requestor. This reduces processing power by not having to receive subsequent or repeat requests for a generated image that will be accepted by the requestor.

Unless otherwise stated, the foregoing alternative examples are not mutually exclusive but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

Although the subject matter herein has been described with reference to particular examples, it is to be understood that these examples are merely illustrative of the principles and applications of the present technology. It is therefore to be understood that numerous modifications may be made to the illustrative examples and that other arrangements may be devised without departing from the spirit and scope of the subject matter as defined by the appended claims.

1. A method, comprising:
receiving, by one or more processors, a signature associated with an entity, wherein the signature includes a plurality of signature elements;
storing, at a memory in communication with the one or more processors, the signature;
receiving, by the one or more processors, a request for an image from a requestor, wherein the request includes the signature and specifications for the image;
in response to receiving the request:
selecting, by the one or more processors, at least one of the plurality of signature elements to incorporate into a response to the request; and
generating, by the one or more processors based on the specifications for the image, an image incorporating at least one of the selected signature elements.

2. The method of claim 1, wherein the signature is a semi-structured set of data composed of multimodal inputs.

3. The method of claim 2, wherein the signature is defined from inputs from a user.

4. The method of claim 2, wherein the signature is defined from inputs from artificial intelligence techniques.

5. The method of claim 1, wherein the selecting further comprises determining which of the plurality of signature elements are compatible with the specifications of the request.

6. The method of claim 1, wherein the selecting comprises selecting less than all of the signature elements to be incorporated into the response for the request.

7. The method of claim 1, wherein the signature elements associated with the entity include at least one of the following: entity name, color, slogan, visual elements of logo, attributes of the entity.

8. The method of claim 1, wherein the request further incorporates a marketing message.

9. The method of claim 1, wherein the request further incorporates at least one target emotion.

10. The method of claim 1, wherein the signature elements are ranked by level of importance, and selecting the at least one signature element is based on the ranking of the signature elements.

11. The method of claim 1 further comprising providing the generated image to the requestor.

12. The method of claim 11, wherein the generated image does not require additional input from the requestor.

13. The method of claim 11, wherein the generated image does not require subsequent or repeat requests for additional images to be generated from the requestor.

14. A system, comprising:
a memory;
one or more processors in communication with the memory, wherein the one or more processors are configured to:
receive a signature associated with an entity, wherein the signature includes a plurality of signature elements;
store, in the memory, the signature;
receive a request for an image from a requestor, wherein the request includes the signature and specifications for the image; and
in response to receiving the request:
select at least one of the plurality of signature elements to incorporate into a response to the request; and
generate, based on the specifications of the request, an image incorporating the at least one of the selected signature elements.

15. The system of claim 14, wherein the signature is a semi-structured set of data composed of multimodal inputs.

16. The system of claim 15 wherein the signature is defined from inputs from a user.

17. The system of claim 14, wherein the signature is defined from inputs from artificial intelligence techniques.

18. The system of claim 14, wherein the one or more processors are further configured to select the plurality of signature elements by determining which of the plurality of signature elements are compatible with the specifications of the request.

19. The system of claim 14, wherein the one or more processors are further configured to select the plurality of signature elements by selecting less than all of the signature elements to be incorporated into the response for the request.

20. A computer-readable medium storing instructions, which when executed by one or more processors, cause the one or more processors to:
receive a signature associated with an entity, wherein the signature includes a plurality of signature elements;
store the signature;
receive a request for an image, wherein the request includes the signature and specifications for the image; and
in response to receiving the request:
select at least one of the plurality of signature elements to incorporate into a response to the request; and
generate, based on the specifications of the request, an image incorporating the at least one of the selected signature elements.
